(19) United States
(12) Patent Application Publication
(10) Pub. No.: US 2015/0143243 A1
(43) Pub. Date: May 21, 2015

(54) HIERARCHICAL PRESENTATION EDITOR

(71) Applicant: International Business Machines Corporation, Armonk, NY (US)

(72) Inventor: Robert A. Balfe, Whitesboro, NY (US)

(73) Assignee: International Business Machines Corporation, Armonk, NY (US)

(21) Appl. No.: 14/085,880

(22) Filed: Nov. 21, 2013

(51) Int. Cl. G06F 17/21

(52) U.S. Cl. CPC G06F 17/211
USPC 715/732

(57) ABSTRACT

In a method for editing slide arrangement within a hierarchical slide presentation, a processor displays a holistic view of a plurality of slides including a first slide and a second slide, wherein the second slide is associated with the first slide in a first parent-child relationship. A processor receives an indication that the first slide is selected. A processor receives an instruction to move the first slide to a location within the holistic view of the plurality of slides. A processor determines that the second slide shall remain associated with the first slide. A processor relocates the first slide to the location within the holistic view of the plurality of slides and relocates the second slide such that the second slide remains associated with the first slide.

### FIELD OF THE INVENTION

The present invention relates generally to the field of presentation software, and more particularly to editing a hierarchical or multi-path slide presentation.

### BACKGROUND OF THE INVENTION

Microsoft® PowerPoint® software provides a user with the ability to create electronic presentations containing one or more slides and the ability to display those slides in a slide show. Displaying slides in a slide show generally involves displaying each slide full screen on a display and sequentially presenting the slides, usually accompanied by a person acting as a presenter or an audio recording.

Microsoft® PowerPoint® software enables a user to create, insert, and edit slides within a presentation. A user may edit the contents of a slide as well as the sequential order in which the slide will be presented during the slide show presentation.

### SUMMARY

Aspects of an embodiment of the present invention disclose a method, computer program product, and computing system for editing slide arrangement within a hierarchical slide presentation. A processor displays a holistic view of a plurality of slides including a first slide and a second slide, wherein the second slide is associated with the first slide in a first parent-child relationship. A processor receives an indication that the first slide is selected. A processor receives an instruction to move the first slide to a location within the holistic view of the plurality of slides. A processor determines that the second slide shall remain associated with the first slide. A processor relocates the first slide to the location within the holistic view of the plurality of slides and relocates the second slide such that the second slide remains associated with the first slide.

### BRIEF DESCRIPTION OF THE SEVERAL VIEWS OF THE DRAWINGS

FIG. 1 depicts a computing system in accordance with one embodiment of the present invention.

FIG. 2 depicts a flowchart of the steps of a slide presentation program executing an editing function within the computing system of FIG. 1 for arranging slides within a slide presentation, in accordance with one embodiment of the present invention.

FIG. 3 is an exemplary user interface window to an editing function, in accordance with one embodiment of the present invention.

FIG. 4 is an exemplary user interface window to a slide presentation program, in accordance with one embodiment of the present invention.

FIG. 5 depicts a block diagram of components of the computing device of FIG. 1, in accordance with one embodiment of the present invention

### DETAILED DESCRIPTION

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The present invention will now be described in detail with reference to the Figures.

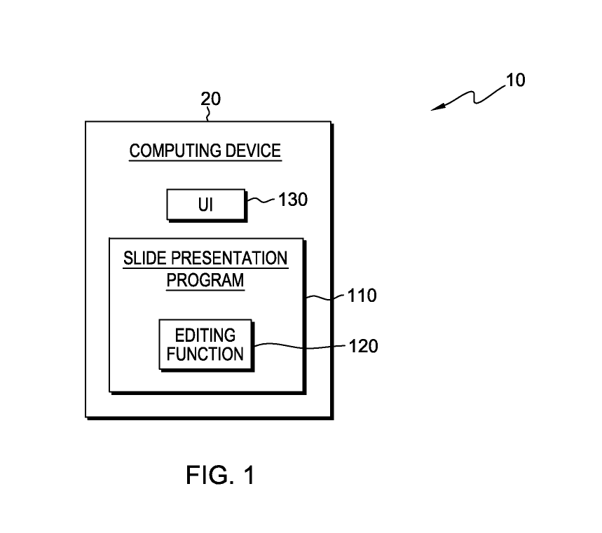

FIG. 1 depicts a diagram of computing system 10 in accordance with one embodiment of the present invention for creating, editing, and viewing hierarchical slide-based presentations. FIG. 1 provides an illustration of one embodiment and does not imply any limitations with regard to the environments in which different embodiments may be implemented.

In the depicted embodiment, computing system 10 includes computing device 20. Computing system 10 may also include a network, servers, computing devices, or other devices not shown.

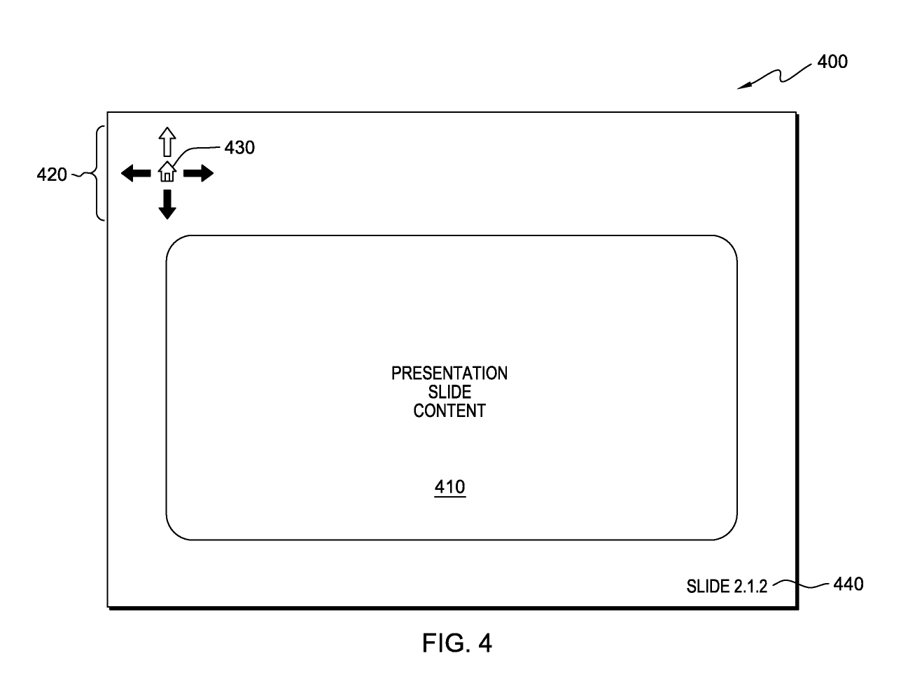

Computing device 20 may be a management server, a web server, personal computer (PC), desktop computer, laptop computer, netbook computer, tablet computer, personal digital assistant (PDA), or smart phone. In general, computing device 20 may be any electronic device capable of sending and receiving data. Computing device 20 includes slide presentation program 110, editing function 120, and user interface (UI) 130. Computing device 20 may include components, as depicted and described in further detail with respect to FIG. 4.

User interface (UI) 130 operates on computing device 20 to generate display signals corresponding to content, such as windows, menus, and icons, and to receive various forms of user input. In one embodiment, UI 130 comprises an interface to editing function 120 and slide presentation program 110. UI 130 may display data received from editing function 120 and slide presentation program 110. UI 130 may send input to editing function 120 and slide presentation program 110. UI 130 may comprise one or more interfaces such as an operating system interface and/or application interfaces.

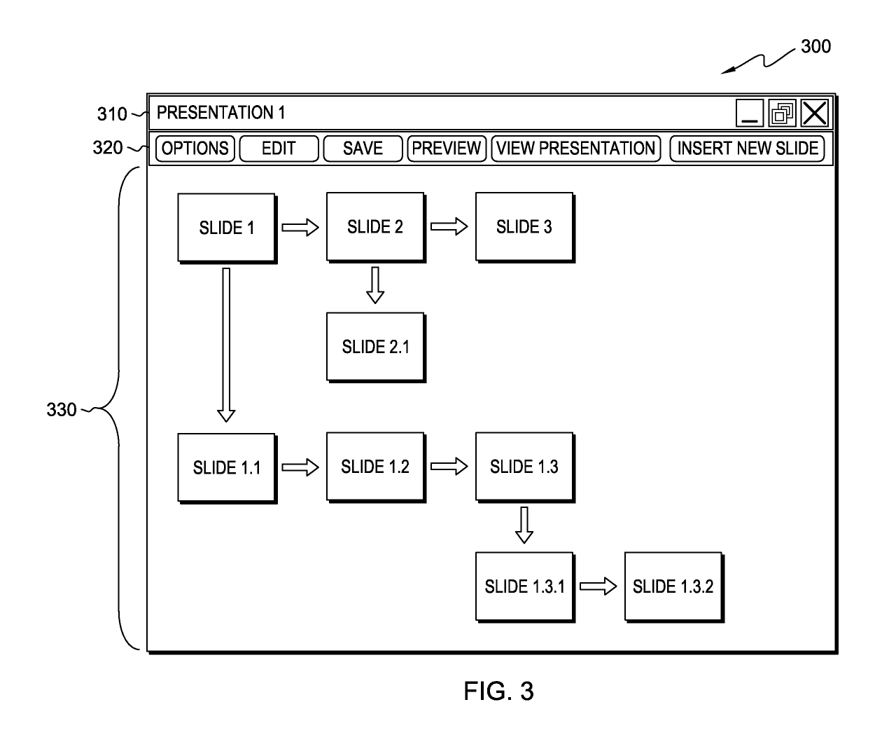

Slide presentation program 110 may be a slide-based presentation program. Slide presentation program 110 may allow a user to create and present a slide-based presentation wherein one or more slides may be cycled through and stored as a single presentation. Slide presentation program 110 may allow for linear or hierarchical arrangements of slides in a single presentation. A linear presentation will have one or more slides arranged in a linear manner. For example, slides may progress in a chronological fashion beginning with a first slide and ending with a last slide. In contrast, a hierarchical arrangement may have multiple paths of associated or children slides that diverge from parent slides during an otherwise linear presentation. FIG. 3 depicts an example of a hierarchical arrangement for a presentation. In one embodiment, slide presentation program 110 resides on computing device 20. In one embodiment, slide presentation program 110 includes editing function 120.

Editing function 120 operates to allow a user to edit a presentation within slide presentation program 110. Editing function 120 may allow a user to position and arrange slides within a hierarchical presentation. Editing function 120 may present a thumbnail based overview of the hierarchical presentation whereby slides may be added and/or moved to desired locations within the hierarchy.

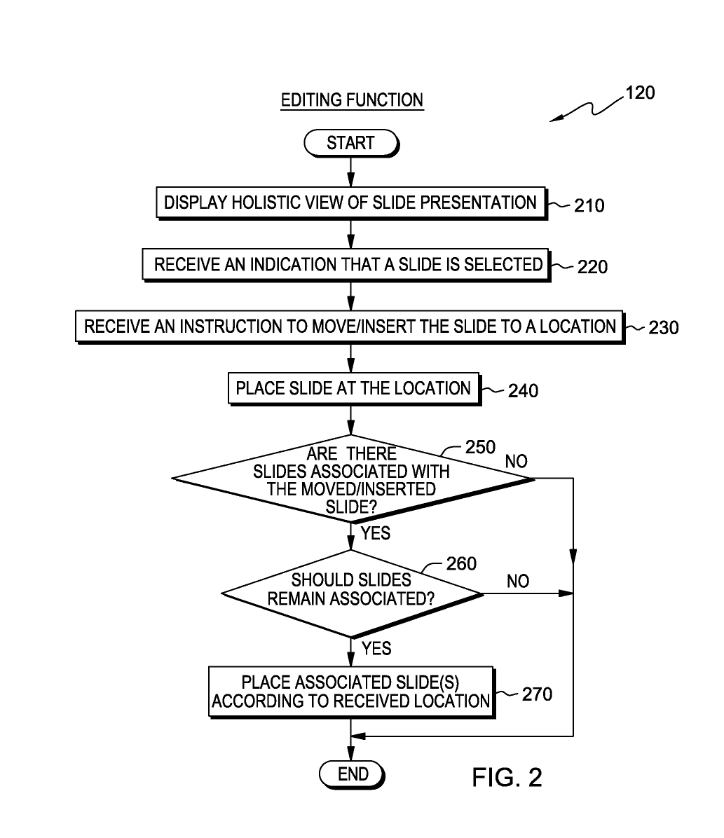

FIG. 2 depicts a flowchart of the steps of editing function 120, a function of slide presentation program 110, executing within the computing system of FIG. 1, in accordance with an embodiment of the present invention. Editing function 120 operates to display a holistic view of the layout of a hierarchical slide presentation and rearrange the layout based on commands and information received from UI 130. Embodiments of editing function 120 may also allow a user to create new slides and add content to slides.

In one embodiment, initially, a user at computing device 20 may create a new slide presentation using slide presentation program 110. Using a function of slide presentation program 110, such as embodiments of editing function 120, a user may create a new slide and add content to that slide. Such content may include text, pictures, movies, audio, hyperlinks, or other types of visual, audible, or written information. A user may add any number of slides and place content upon each slide based upon the requirements for the particular presentation. Once multiple slides are placed within a presentation, a user may use editing function 120 to rearrange the order of the slides or create associated or parent/child relationships between two or more slides. In addition to parent/child relationships between slides that branch off of the linear path of the slide presentation, a chronological relationship may exist between slides on the same linear path. For example, there is a chronological relationship between slide 1 and slide 2, as depicted on FIG. 3. Also depicted on FIG. 3 is a second chronological relationship between slide 1.2 and slide 1.3.

In step 210, editing function 120 displays a holistic overview of the open slide presentation. FIG. 3 depicts an example of one embodiment of such a holistic overview. In general, the holistic overview of the open slide presentation will depict the entire layout or a reasonably large portion of the slide presentation. Such a layout will depict parent/child relationships between associated slides and may include a numbering system or other method of organizing the presentation layout. Methods of organizing the presentation layout may include arrows indicating one or more paths in the presentation, labels located on or near each slide (e.g., child of slide 1, etc.) and/or a numbering system, such as the numbering system depicted in FIG. 3. In one embodiment, the layout will include thumbnail images of each slide in the presentation. In such an embodiment, there may be an option that allows for the thumbnail image to be temporarily replaced with an indication of the location within the slide presentation. For example, there may be an option that causes the thumbnail images to be replaced with a numbering system indicating what position the slide is located at within the slide presentation. In some embodiments, if a large number of slides exist in the presentation, an option may allow a user to scale the view of the layout of the slides in order to increase the viewing area of the layout. In another embodiment, the window may include scrolling arrows for scrolling horizontally and/or vertically to view all of the slides.

In step 220, editing function 120 receives an indication that a slide has been selected. In one embodiment, UI 130 may send an indication to editing function 120 that a user at computing device 20 has selected a slide. In some embodiments, a selection may be initiated by a user by clicking on the slide using a mouse and cursor, touch screen, or other method of selection. In other embodiments, rather than selecting a slide, a drag and drop selection process may be used.

In step 230, editing function 120 receives an instruction to move or insert the selected slide to a location. If the slide previously existed within the presentation, editing function 120 receives an instruction to move the selected slide to a location. If the slide has been newly created, editing function 120 may receive an instruction to insert the slide at a location. In one embodiment, once a slide has been selected, the location to move or insert the slide may be the next received selection, such as a selection received via a mouse and cursor or touch screen input. In an embodiment that uses drag and drop, the received location to move or insert the slide may be the location where the slide has been dropped, after being dragged, such as when a user drags by clicking the left mouse button and holding the button down, and drops by releasing the left mouse button at the desired location.

In step 240, editing function 120 places the slide at the received location according to the instruction (see step 230). In one embodiment, selecting a location in between two slides will insert the slide in between the two slides and surrounding slides will relocate as necessary. For example, if the selected location is in between a first slide and a second slide, the moved slide may take the position of the second slide, the original second slide will become the third slide, and the original first slide will continue to be the first slide. In some embodiments, if the received location is another slide, editing function 120 may cause the inserted or moved slide to become a child slide with respect to the slide located at the received location.

In decision 250, editing function 120 determines if there are other slides associated with the moved or inserted slide, such as slides associated by a parent/child relationship. If editing function 120 determines that there are no such associated slides (decision 250, no branch), the function is complete. Editing function 120 may determine that there are no slides associated with the moved or inserted slide by looking to the hierarchical layout of the presentation. Typically, the linear aspect of a hierarchical presentation will progress in a chronological or numerical fashion, while associated slides may exist that break away from that organizational layout.

If editing function 120 determines that there are slides associated with the moved or inserted slide (decision 250, yes branch), editing function 120 will determine whether the slides should remain associated (decision 260). In some embodiments, editing function 120 may determine that there are slides associated with the moved or inserted slide by the hierarchical layout of the presentation. In other embodiments, editing function 120 may determine that such a relationship exists based on previously input information, such as if the user actively associated the slides by selecting a slide when rearranging slides (see step 230).

If editing function 120 determines that the associated slides should not remain associated with the moved or inserted slide (decision 260, no branch), the function is complete. If such a determination is made, any previously associated slides will remain in the original location along the presentation hierarchy. In some embodiments, such slides may automatically become associated with nearby slides along the presentation hierarchy. In other embodiments, the slides may have a broken link and request a user to select an association, or otherwise rearrange the slide layout to remedy the broken link. In still other embodiments, editing function 120 may prompt the user regarding the deletion of associated slides, and based on the received response, determine if the associated slides should be deleted from the presentation.

If editing function 120 determines that the associated slides should remain associated with the moved or inserted slide (decision 260, yes branch), editing function 120 will place the associated slides according to the received location (step 270). For example, children slides of the moved or inserted slide will remain children slides of the moved or inserted slide and their location along the hierarchical presentation will adjust accordingly. In some embodiments, editing function 120 may generate a prompt to query a user at computing device 20, and based on the received response, determine that the associated slides should remain associated with the moved or inserted slide. Once the associated slides have been moved, the function is complete.

FIG. 3 is an exemplary user interface window to slide presentation program 110 executing editing function 120 in accordance with one embodiment of the present invention. User interface window 300 may be a user interface window to slide presentation program 110 of computing device 20. User interface window 300 allows a user to edit the arrangement of slides in a hierarchical slide presentation. User interface window 300 also allows a user to insert a new slide or select and edit the content of an existing slide.

User interface window 300 includes title bar 310, options toolbar 320, and slide arrangement area 330. Title bar 310 indicates information about the contents of the window, such as the filename of the depicted slide presentation. Options toolbar 320 may include various option buttons or menus. In the depicted embodiment, options toolbar 320 includes an options button, an edit button, a save button, a preview button, a view presentation button, and an insert new slide button. Other embodiments may include different option buttons or menus, or different arrangements of such option buttons or menus. In the depicted embodiment, the insert new slide button creates a new slide to insert into the slide presentation. The view presentation button will display the slide presentation as a slideshow, in some embodiments the slideshow may be depicted as shown in FIG. 4. The preview button may show a print preview for if a user were to print a handout version of the slide presentation. The save button may allow a user to save both the contents and arrangement of the slides to tangible storage located on computing device 20 or to another location. The edit button may allow a user to select a slide to edit, such as by clicking on the slide with a cursor and mouse. Alternatively, a user may be able to select a slide to edit by double-clicking on a slide or right-clicking and selecting an edit option from a pop-up menu. The options button may include additional options, such as presentation theme, animations, color schemes, or other options typically found in slide presentation software.

Slide arrangement area 330 is an area within which slides may be arranged in a hierarchical order, in the manner discussed with regards to FIG. 2. In the depicted embodiment, slide arrangement area 330 is arranged such that the top row contains the linear set of slides or the parent slides within the presentation. As discussed with respect to FIG. 2, a user may associate a slide with a parent slide, thus creating an associated or child slide. In the depicted example, slide 1.1 is a child slide with respect to slide 1. Additional slides may be associated with children slides which will create additional parent/child or slide associations. In the depicted example, all lower rows are associated with the slide that contains a downward facing arrow. For example, slides 1.1, 1.2, and 1.3 are all associated with slide 1, and slides 1.3.1 and 1.3.2 are associated with both slide 1.3 and slide 1. A user may rearrange slides by selecting a slide and dragging it to a desired location. As previously discussed, if the moved slide has associated children slides, a prompt may appear asking the user if such slides should remain associated, and if so the associated slides will also be moved to the corresponding location. It should be recognized that this is one possible arrangement, and other arrangements or organizational methods may be contemplated by one of ordinary skill in the art.

FIG. 4 is an exemplary user interface window to slide presentation program 110 in accordance with one embodiment of the present invention. User interface window 400 may be a user interface window to slide presentation program 110 of computing device 20 of FIG. 1. User interface window 400 allows a user to navigate through a previously stored hierarchical slide presentation. In some embodiments, user interface window 400 may be a full screen window, such that user interface window 400 takes up the entirety of the display on which user interface window 400 is presented. In the depicted embodiment, user interface window 400 is shown as viewed by a user who has selected to view the slide show of a slide presentation.

User interface window 400 includes slide content 410, navigation arrows 420, home button 430, and location information 440. Slide content 410 may include any type of information that could be located on a slide such as text, images, videos, hyperlinks, or other information. Navigation arrows 420 may allow a user to navigate the slide presentation. Home button 430 may allow a user to navigate to the beginning of the slide presentation, or alternatively, to the slide from which the currently depicted slide associates (i.e., slide 2 if the depicted slide is slide 2.3). Location information 440 may display the name of the slide, slide number, or other information about the slide.

As previously mentioned, navigation arrows 420 may allow a user to navigate the slide presentation. Typically, navigation arrows 420 will allow a user to progress the slideshow in a linear path by selecting the left arrow to go backwards in the presentation, and the right arrow to go forwards in the presentation. For example, if the depicted slide is slide 2, selecting the right navigation arrow may cause the presentation to move to slide 3. The up and down arrows may allow a user to deviate from the linear path. In the depicted embodiment, the up and down arrows may allow a user to navigate between associated slides within the hierarchical presentation. For example, slide 2 may have associated or children slides, such as slides 2.1-2.4. When such associated slides exist, they may be accessed by the down navigation arrow of navigation arrows 420. When an associated or child slide is depicted, the parent slide may be accessed by the up navigation arrow of navigation arrows 420. A parent slide is any slide from which another slide associates.

In some embodiments, the display of each arrow of navigation arrows 420 may change to reflect whether or not there is an accessible slide along that direction of the hierarchical slide presentation. For example, in the depicted embodiment, the left, down, and right arrows are black, while the up arrow is white. In this embodiment, the black arrows indicate that there is a slide in that direction along the hierarchy, while the white arrow indicates that there is not a slide in that direction along the hierarchy. In one embodiment, a user may select the arrows with a cursor. In another embodiment, a user may use arrows located on a keyboard or other input device, rather than selecting navigation arrows 420, as depicted on FIG. 4.

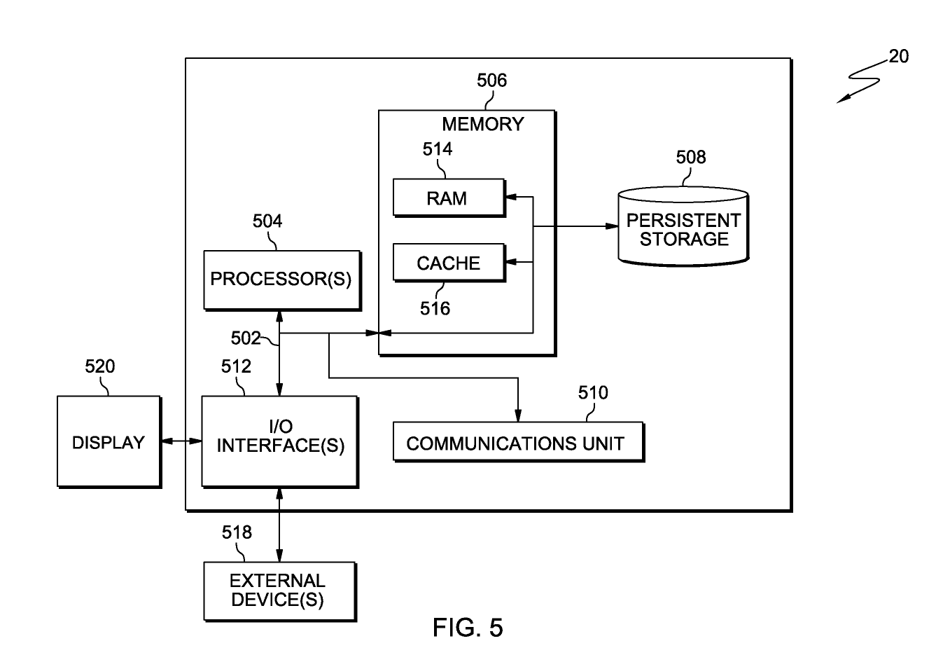

FIG. 5 depicts a block diagram of components of computing device 20 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computing device 20 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Slide presentation program 110 and editing function 120 are stored in persistent storage 508 of computing device 20 for execution by one or more of the respective computer processors 504 of computing device 20 via one or more memories of memory 506 of computing device 20. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Slide presentation program 110 and editing function 120 may be downloaded to persistent storage 508 of computing device 20 through communications unit 510 of computing device 20.

I/O interface(s) 512 allows for input and output of data with other devices that may be connected to computing device 20. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., slide presentation program 110 and editing function 120, can be stored on such portable computer-readable storage media and can be loaded onto persistent storage 508 of computing device 20 via I/O interface(s) 512 of computing device 20. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for editing a slide arrangement within a hierarchical slide presentation, the method comprising:
displaying a holistic view of a plurality of slides including a first slide and a second slide, wherein the second slide is associated with the first slide in a first parent-child relationship;
receiving an indication that the first slide is selected;
receiving an instruction to move the first slide to a location within the holistic view of the plurality of slides;
determining, by one or more processors, that the second slide shall remain associated with the first slide; and
relocating the first slide to the location within the holistic view of the plurality of slides and relocating the second slide such that the second slide remains associated with the first slide.

2. The method of claim 1, wherein the step of determining, by one or more processors, that the second slide shall remain associated with the first slide comprises the steps of:
generating a prompt, wherein the prompt includes an indication that the second slide is associated with the first slide and a query as to whether the second slide shall remain associated with the first slide; and
receiving a response to the prompt indicating that the second slide shall remain associated with the first slide.

3. The method of claim 1, wherein the location within the holistic view of the plurality of slides is a third slide.

4. The method of claim 3, wherein the step of relocating the first slide to the location within the holistic view of the plurality of slides and relocating the second slide such that the second slide remains associated with the first slide includes relocating the first slide such that the first slide is associated with the third slide as a child in a second parent-child relationship.

5. The method of claim 1, wherein the holistic view of the plurality of slides includes at least a thumbnail view of each slide of the hierarchical slide presentation and an indication of relationships between each slide of the hierarchical slide presentation.

6. The method of claim 1, wherein the holistic view of the plurality of slides includes a first set of slides arranged in a linear manner, wherein the first slide is included within the set of slides arranged in a linear manner; and
wherein the second slide is a beginning slide to a second set of slides arranged in a linear manner, wherein each slide included in the second set of slides is associated with the first slide.

7. The method of claim 1, further comprising:
relocating surrounding slides of the plurality of slides as necessary based on the relocation of the first slide at the location within the holistic view of the plurality of slides; and
generating a relationship between the first slide and at least one of the surrounding slides of the plurality of slides as necessary based on the relocation of the first slide at the location within the holistic view of the plurality of slides.

8. A computer program product for editing a slide arrangement within a hierarchical slide presentation, the computer program product comprising:
one or more computer-readable storage media and program instructions stored on the one or more computer-readable storage media, the program instructions comprising:
program instructions to display a holistic view of a plurality of slides including a first slide and a second slide, wherein the second slide is associated with the first slide in a first parent-child relationship;
program instructions to receive an indication that the first slide is selected;
program instructions to receive an instruction to move the first slide to a location within the holistic view of the plurality of slides;
program instructions to determine that the second slide shall remain associated with the first slide; and
program instructions to relocate the first slide to the location within the holistic view of the plurality of slides and relocate the second slide such that the second slide remains associated with the first slide.

9. The computer program product of claim 8, wherein program instructions to determine that the second slide shall remain associated with the first slide comprise:
program instructions to generate a prompt, wherein the prompt includes an indication that the second slide is associated with the first slide and a query as to whether the second slide shall remain associated with the first slide; and
program instructions to receive a response to the prompt indicating that the second slide shall remain associated with the first slide.

10. The computer program product of claim 8, wherein the location within the holistic view of the plurality of slides is a third slide.

11. The computer program product of claim 10, wherein program instructions to relocate the first slide to the location within the holistic view of the plurality of slides and relocate the second slide such that the second slide remains associated with the first slide includes program instructions to relocate the first slide such that the first slide is associated with the third slide as a child in a second parent-child relationship.

12. The computer program product of claim 8, wherein the holistic view of the plurality of slides includes at least a thumbnail view of each slide of the hierarchical slide presentation and an indication of relationships between each slide of the hierarchical slide presentation.

13. The computer program product of claim 8, wherein the holistic view of the plurality of slides includes a first set of slides arranged in a linear manner, wherein the first slide is included within the set of slides arranged in a linear manner; and
wherein the second slide is a beginning slide to a second set of slides arranged in a linear manner, wherein each slide included in the second set of slides is associated with the first slide.

14. The computer program product of claim 8, further comprising:
program instructions, stored on the one or more computer-readable storage media, to relocate surrounding slides of the plurality of slides as necessary based on the relocation of the first slide at the location within the holistic view of the plurality of slides; and
program instructions, stored on the one or more computer-readable storage media, to generate a relationship between the first slide and at least one of the surrounding slides of the plurality of slides as necessary based on the relocation of the first slide at the location within the holistic view of the plurality of slides.

15. A computer system for editing a slide arrangement within a hierarchical slide presentation, the computer system comprising:
one or more computer processors, one or more computer-readable storage media, and program instructions stored on the computer-readable storage media for execution by at least one of the one or more processors, the program instructions comprising:
program instructions to display a holistic view of a plurality of slides including a first slide and a second slide, wherein the second slide is associated with the first slide in a first parent-child relationship;
program instructions to receive an indication that the first slide is selected;
program instructions to receive an instruction to move the first slide to a location within the holistic view of the plurality of slides;
program instructions to determine that the second slide shall remain associated with the first slide; and
program instructions to relocate the first slide to the location within the holistic view of the plurality of slides and relocate the second slide such that the second slide remains associated with the first slide.

16. The computer system of claim 15, wherein program instructions to determine that the second slide shall remain associated with the first slide comprise:
program instructions to generate a prompt, wherein the prompt includes an indication that the second slide is associated with the first slide and a query as to whether the second slide shall remain associated with the first slide; and
program instructions to receive a response to the prompt indicating that the second slide shall remain associated with the first slide.

17. The computer system of claim 15, wherein the location within the holistic view of the plurality of slides is a third slide.

18. The computer system of claim 17, wherein program instructions to relocate the first slide to the location within the holistic view of the plurality of slides and relocate the second slide such that the second slide remains associated with the first slide includes program instructions to relocate the first slide such that the first slide is associated with the third slide as a child in a second parent-child relationship.

19. The computer system of claim 15, wherein the holistic view of the plurality of slides includes at least a thumbnail view of each slide of the hierarchical slide presentation and an indication of relationships between each slide of the hierarchical slide presentation.

20. The computer system of claim 15, wherein the holistic view of the plurality of slides includes a first set of slides arranged in a linear manner, wherein the first slide is included within the set of slides arranged in a linear manner; and
wherein the second slide is a beginning slide to a second set of slides arranged in a linear manner, wherein each slide included in the second set of slides is associated with the first slide.
